(19) United States
(12) Patent Application Publication
(10) Pub. No.: US 2025/0267135 A1
(43) Pub. Date: Aug. 21, 2025

(54) ACCESS TOKEN MISSING CLAIM HANDLING

(71) Applicant: Nokia Technologies Oy, Espoo (FI)

(72) Inventors: Harish MURALIDHARA, Bangalore (IN); Sireesha BOMMISETTY, Bangalore (IN); Saurabh KHARE, Bangalore (IN); Mallikarjunudu MAKHAM, Bangalore (IN); Topuri BRAHMAIAH, Bangalore (IN); Jos GEORGE, Bangalore (IN); Bruno LANDAIS, Lannion (FR)

(21) Appl. No.: 18/958,651

(22) Filed: Nov. 25, 2024

(30) Foreign Application Priority Data
Feb. 15, 2024 (IN) 202441010571

(51) Int. Cl. H04L 9/40

(52) U.S. Cl. CPC H04L 63/08

(57) ABSTRACT

A method implemented at a network function service producer (NFp) is provided. The method includes receiving a service request from a network function service consumer (NFc) for access to a service provided by the NFp. The request includes an access token that asserts one or more claims and represents an access authorization issued to the NFc. The method includes performing a validation of the access token in which a determination is made that at least one claim is missing from the one or more claims asserted by the access token. And based on the validation, the method includes sending an error response to the NFc that indicates the service request is rejected, and that indicates the at least one missing claim. A corresponding method implemented at the NFC is also provided.

### TECHNOLOGICAL FIELD

The present disclosure relates generally to telecommunications and, in particular, to security procedures, such as authorization procedures, in a telecommunications system.

### BACKGROUND

A telecommunications system can be seen as a facility that enables communication sessions between two or more entities such as user terminals, base stations and/or other nodes by providing carriers between the various entities involved in the communications path. A telecommunications system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless telecommunications system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the telecommunications system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The telecommunications system and associated devices typically operate in accordance with a given standard or specification which sets out what the various entities associated with the system are permitted to do and how that should be achieved. Communication protocols and/or parameters which shall be used for the connection are also typically defined. One example of a telecommunications system is the Universal Mobile Telecommunications System (UMTS). Other examples of telecommunications systems are Long-Term Evolution (LTE), LTE Advanced and the so-called 5G or New Radio (NR) networks. NR is being standardized by the 3rd Generation Partnership Project (3GPP).

### BRIEF SUMMARY

Example implementations of the present disclosure are directed to telecommunications and, in particular, to security procedures, such as authorization procedures, in a telecommunications system. The present disclosure includes, without limitation, the following example implementations.

Some example implementations provide an apparatus to implement a network function service producer (NFp), the apparatus comprising: at least one memory configured to store instructions; and at least one processing circuitry configured to access the at least one memory, and execute the instructions to cause the apparatus to at least: receive a service request from a network function service consumer (NFc) for access to a service provided by the NFp, the request including an access token that asserts one or more claims and represents an access authorization issued to the NFc; perform a validation of the access token in which a determination is made that at least one claim is missing from the one or more claims asserted by the access token; and based on the validation, send an error response to the NFc that indicates the service request is rejected, and that indicates the at least one missing claim.

Some example implementations provide a apparatus to implement a network function service producer (NFp), the apparatus comprising: means for receiving a service request from a network function service consumer (NFc) for access to a service provided by the NFp, the request including an access token that asserts one or more claims and represents an access authorization issued to the NFc; means for performing a validation of the access token in which a determination is made that at least one claim is missing from the one or more claims asserted by the access token; and based on the validation, means for sending an error response to the NFc that indicates the service request is rejected, and that indicates the at least one missing claim.

Some example implementations provide a method implemented at a network function service producer (NFp), the method comprising: receiving a service request from a network function service consumer (NFc) for access to a service provided by the NFp, the request including an access token that asserts one or more claims and represents an access authorization issued to the NFc; performing a validation of the access token in which a determination is made that at least one claim is missing from the one or more claims asserted by the access token; and based on the validation, sending an error response to the NFc that indicates the service request is rejected, and that indicates the at least one missing claim.

Some example implementations provide a computer-readable storage medium implemented at a network function service producer (NFp), the computer-readable storage medium being non-transitory and having instructions stored therein that, in response to execution by at least one processing circuitry, causes an apparatus to at least: receive a service request from a network function service consumer (NFc) for access to a service provided by the NFp, the request including an access token that asserts one or more claims and represents an access authorization issued to the NFc; perform a validation of the access token in which a determination is made that at least one claim is missing from the one or more claims asserted by the access token; and based on the validation, send an error response to the NFc that indicates the service request is rejected, and that indicates the at least one missing claim.

Some example implementations provide an apparatus to implement a network function service consumer (NFc), the apparatus comprising: at least one memory configured to store instructions; and at least one processing circuitry configured to access the at least one memory, and execute the instructions to cause the apparatus to at least: send a service request to a network function service producer (NFp) for access to a service provided by the NFp, the service request including an access token that asserts one or more claims and represents an access authorization issued to the NFc; receive an error response from the NFp that indicates the service request is rejected, and that indicates at least one claim that is missing from the one or more claims asserted by the access token; and base on the error response, retrieve a second access token that asserts a plurality of claims including the one or more claims and the at least one missing claim.

Some example implementations provide a apparatus to implement a network function service consumer (NFc), the apparatus comprising: means for sending a service request to a network function service producer (NFp) for access to a service provided by the NFp, the service request including an access token that asserts one or more claims and represents an access authorization issued to the NFc; means for receiving an error response from the NFp that indicates the service request is rejected, and that indicates at least one claim that is missing from the one or more claims asserted by the access token; and based on the error response, means for retrieving a second access token that asserts a plurality of claims including the one or more claims and the at least one missing claim.

Some example implementations provide a method implemented at a network function service consumer (NFc), the method comprising: sending a service request to a network function service producer (NFp) for access to a service provided by the NFp, the service request including an access token that asserts one or more claims and represents an access authorization issued to the NFc; receiving an error response from the NFp that indicates the service request is rejected, and that indicates at least one claim that is missing from the one or more claims asserted by the access token; and based on the error response, retrieving a second access token that asserts a plurality of claims including the one or more claims and the at least one missing claim.

Some example implementations provide a computer-readable storage medium implemented at a network function service consumer (NFc), the computer-readable storage medium being non-transitory and having instructions stored therein that, in response to execution by at least one processing circuitry, causes an apparatus to at least: send a service request to a network function service producer (NFp) for access to a service provided by the NFp, the service request including an access token that asserts one or more claims and represents an access authorization issued to the NFc; receive an error response from the NFp that indicates the service request is rejected, and that indicates at least one claim that is missing from the one or more claims asserted by the access token; and base on the error response, retrieve a second access token that asserts a plurality of claims including the one or more claims and the at least one missing claim.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a telecommunications system that includes one or more public land mobile networks (PLMNs) coupled to one or more external data networks, according to some example implementations of the present disclosure;

FIG. 2 illustrates a telecommunications system that includes two PLMNs, in accordance with some example implementations;

FIGS. 3 and 4 are signaling charts of access token request and validation, according to various example implementations;

FIG. 5 is a flowchart illustrating various steps in a method implemented at a network function service producer (NFp), according to some example implementations;

FIGS. 6A, 6B, 6C and 6D are flowcharts illustrating various steps in a method 600 implemented at a network function service consumer (NFc), according to various example implementations;

FIG. 7 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably. The term “network” may refer to a group of interconnected computers including clients and servers; and within a network, these computers may be interconnected directly or indirectly by various means including via one or more switches, routers, gateways, access points or the like.

Reference may be made herein to terms specific to a particular system, architecture or the like, but it should be understood that example implementations of the present disclosure may be equally applicable to any of a number of systems, architectures and the like. For example, reference may be made to 3GPP technologies such as Global System for Mobile Communications (GSM), UMTS, LTE, LTE Advanced, 5G NR, 5G Advanced and 6G; however, it should be understood that example implementations of the present disclosure may be equally applicable to non-3GPP technologies such as IEEE 802, Bluetooth and Bluetooth Low Energy.

Further, as used in this application, the term “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); or (c) hardware circuit(s) and/or processor(s), such as a microprocessor(s) or a portion of a microprocessor(s), that requires software (e.g., firmware) for operation, but the software may not be present when it is not needed for operation.

The above definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

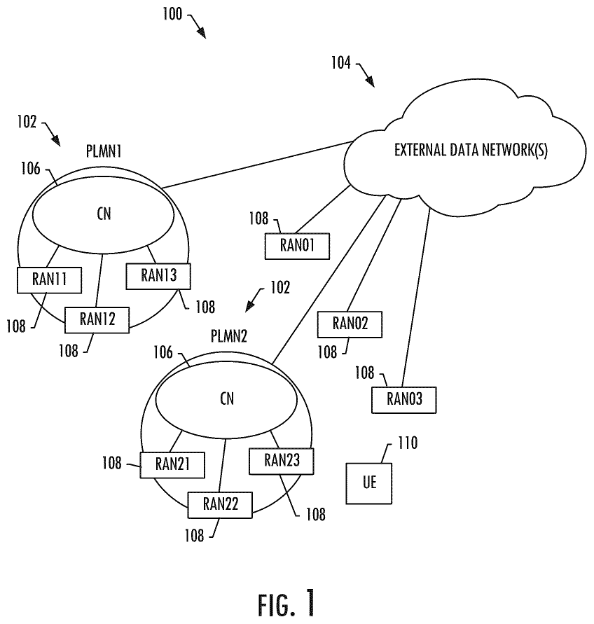

FIG. 1 illustrates a telecommunications system 100 according to various example implementations of the present disclosure. The telecommunications system generally includes one or more telecommunications networks. As shown, for example, the system includes one or more public land mobile networks (PLMNs) 102 coupled to one or more other external data networks 104—notably including a wide area network (WAN) such as the Internet. Each of the PLMNs includes a core network (CN) 106 backbone such as the Evolved Packet Core (EPC) of LTE, the 5G core network (5GC) or the like; and each of the core networks and the Internet are coupled to one or more radio access networks (RANs) 108, air interfaces or the like that implement one or more radio access technologies (RATs). As used herein, a “network device” refers to any suitable device at a network side of a telecommunications network. Examples of suitable network devices are described in greater detail below.

In addition, the system includes one or more radio units that may be varyingly known as user equipment (UE) 110, terminal device, terminal equipment, mobile station or the like. The UE is generally a device configured to communicate with a network device or a further UE in a telecommunications network. The UE may be a portable computer (e.g., laptop, notebook, tablet computer), mobile phone (e.g., cell phone, smartphone), wearable computer (e.g., smartwatch), or the like. In other examples, the UE may be an Internet of things (IoT) device, an industrial IoT (IIoT device), a vehicle equipped with a vehicle-to-everything (V2X) communication technology, or the like. In some examples, as referenced by 3GPP, the UE may be a narrowband IoT (NB-IoT) device, an enhanced machine-type communication (eMTC) device, a reduced capability (RedCap) device, an ambient IoT device, or the like.

In operation, these UEs 110 may be configured to connect to one or more of the RANs 108 according to their particular radio access technologies to thereby access a particular CN 106 of a PLMN 102, or to access one or more of the external data networks 104 (e.g., the Internet). The external data network may be configured to provide Internet access, operator services, 3rd party services, etc. For example, the International Telecommunication Union (ITU) has classified 5G mobile network services into three categories: enhanced mobile broadband (eMBB), ultra-reliable and low-latency communications (URLLC), and massive machine type communications (mMTC) or massive internet of things (MIoT).

Examples of radio access technologies include 3GPP radio access technologies such as GSM, UMTS, LTE, LTE Advanced, 5G NR, 5G Advanced, and 6G. Other examples of radio access technologies include IEEE 802 technologies such as IEEE 802.11 (Wi-Fi), IEEE 802.15 (including 802.15.1 (WPAN/Bluetooth), 802.15.4 (Zigbee) and 802.15.6 (WBAN)), Bluetooth, Bluetooth Low Energy (BLE), ultra wideband (UWB), and the like. Generally, a radio access technology may refer to any 2G, 3G, 4G, 5G, 6G or higher generation mobile communication technology and their different versions, as well as to any other wireless radio access technology that may be arranged to interwork with such a mobile communication technology to provide access to the CN 106 of a mobile network operator (MNO).

In various examples, a RAN 108 may be configured as one or more macrocells, microcells, picocells, femtocells or the like. The RAN may generally include one or more radio access nodes that are configured to interact with UEs 110. In various examples, a radio access node may be referred to as a base station (BS), access point (AP), base transceiver station (BTS), Node B (NB), evolved NB (eNB), macro BS, NB (MNB) or eNB (MeNB), home BS, NB (HNB) or eNB (HeNB), next generation NB (gNB), enhanced gNB (en-gNB), next generation eNB (ng-eNB), or the like. The RAN may include some type of network controlling/governing entity responsible for control of the radio access nodes. The network controlling/governing entity and radio access node may be separate or integrated into a single apparatus. The network controlling/governing entity may include processing circuitry configured to carry out various management functions, etc. The processing circuitry may be associated with a memory, computer-readable storage medium or database for maintaining information required in the management functions.

A RAN 108 may be centralized or distributed. In various examples, components of a RAN may be interconnected by Ethernet, Gigabit Ethernet, Asynchronous Transfer Mode (ATM), optical fiber, dark fiber, passive wavelength division multiplexing (WDM), WDM passive optical network (WDM-PON), optical transport network (OTN), time sensitive networking (TSN) and/or any other data link layer network, possibly including radio links. The RAN may be connected to a CN 106 through one or more gateways, network functions or the like.

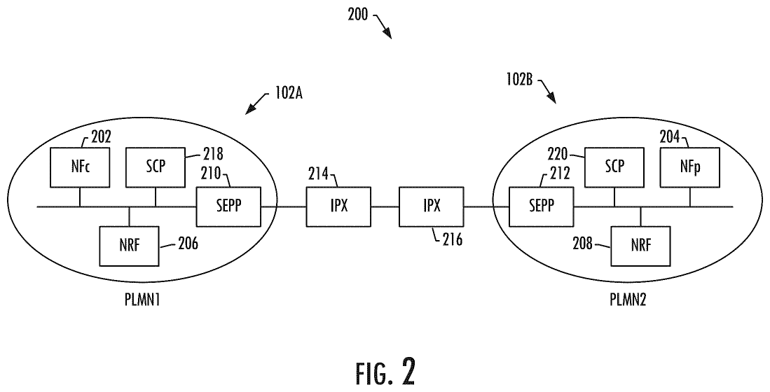

FIG. 2 illustrates a telecommunications system 200 that includes two PLMNs 102A, 102B, in accordance with some example implementations of the present disclosure. As shown, each of the PLMNs is equipped with a number of network functions (NFs), two of which are shown as respectively a NF service consumer (NFc) 202 and a NF service producer (NFp) 204. A network function may refer to an operational and/or a physical entity. A network function may be a specific network node or element, or a specific function or set of functions carried out by one or more entities, such as virtualized network elements (VNFs). One physical node may be configured to perform plural NFs. A network function can be implemented either as a network element on a dedicated hardware, as a software instance running on a dedicated hardware, or as a virtualized function instantiated on an appropriate platform, e.g., on a cloud infrastructure. Examples of such network functions include a resource control or management function, session management or control function, interworking, data management or storage function, authentication function or a combination of one or more of these functions.

In the context of a 3GPP 5G service based architecture (SBA), core network NFs may include one or more of an access and mobility management function (AMF), a session management function (SMF), a network slice selection function (NSSF), a network exposure function (NEF), a network repository function (NRF) 206, 208, a unified data management (UDM), an authentication server function (AUSF), a policy control function (PCF), an application function (AF), or the like. The PLMNs may each further include a security edge protection proxy (SEPP) 210, 212 configured to operate as a security edge node or gateway.

In some examples, the NFs may communicate with each other using representational state transfer application programming interfaces (APIs), which may be known as Restful APIs. Further examples of NFs include NFs related to gaming, streaming or industrial process control. The telecommunications system may also include nodes from 3G or 4G node systems, such as home subscriber server (HSS), and a suitable interworking function for protocol translations between, e.g., diameter and REST API JSON (JavaScript Object Notation). While described herein primarily using terminology of 5G systems, example implementations of the present disclosure may be applicable also to other communication networks using proxies as described herein, such as 4G networks and non-3GPP networks.

Although the telecommunications system 200 is illustrated with two PLMNs 102A, 102B, in general at least some example implementations may be practiced in a single PLMN, which need not necessarily have SEPPs. In an inter-PLMN case, the SEPP 210, 212 is a network node at the boundary of a MNO's network that may be configured to receive a message, such as a Hypertext Transfer Protocol (HTTP) request message or HTTP response message from an NF, to apply protection for sending and to forward the reformatted message through a chain of intermediate nodes, such as IP eXchanges (IPXs) 214, 216, towards a receiving SEPP. The receiving SEPP receives a message sent by the sending SEPP and forwards the message towards an NF within its MNO's network (e.g., the AUSF).

In the example of FIG. 2, an NF service may be provided for a NFc 202 by a NFp 204. As noted, the NFc and NFp may reside in different PLMNs 102A, 102B or the NFc and NFp may reside in the same PLMN.

In some examples, a service communication proxy (SCP) 218, 220 may be deployed for indirect communication between NFs. An SCP is an intermediate network entity to assist in indirect communication between an NFc 202 and an NFp 204, including routing messages, such as control plane messages between the NFs. The SCP may discover and select NFp on behalf of NFc. The SCP may request an access token from the NRF 206, 208 or an authorization server on behalf of NFc to access the service of NFp.

Direct communication may be applied between NFc 202 and NFp 204 for an NF service, or NF service communication may be performed indirectly via SCP(s) 218, 220. In direct communication, the NFc performs discovery of the target NFp by local configuration or via local NRF 206 (this NRF may be referred to as a NRFc). In indirect communication, the NFc may delegate the discovery of the target NFp to the SCP 218. In the latter case, the SCP may use the parameters provided by NFc to perform discovery and/or selection of the target NFp, such as with reference to one or more NRFs 206, 208.

NF discovery and NF service discovery enable entities, such as NFc 202 or SCP 218, to discover a set of NF instance(s) and NF service instance(s) for a specific NF service or an NFp type. The NFc and/or the SCP may be core network entities. The NRF may include a function that is used to support the functionality of NF and NF service registration, discovery, authorization and status notification. Additionally or alternatively, the NRF 206, 208 may be configured to act as an authorization server. The NRF may maintain an NF profile of available NFp entities and their supported services. The NRF may notify about newly registered, updated, or deregistered NFp entities along with its NF services to a subscribed NFc or SCP. An NRF may thus advise NFc entities or SCP concerning where, that is, from which NFp entities, they may obtain services they need. In general, an NRF is a terminological example of a network support node, and an SCP is a terminological example of a proxy entity. An NRF may be separate from or co-located with an SCP, or even hosted by a service provider.

In order for the NFc 202 or SCP 218 to obtain information about the NFp and/or NF service(s) registered or configured in a PLMN/slice, the NFc or SCP may initiate, based on local configuration, a discovery procedure with an NRF, such as NRF 206. The discovery procedure may be initiated by providing the type of the NFp 204 and optionally a list of the specific service(s) it is attempting to discover. The NFc or SCP may additionally or alternatively provide other service parameters, such as information relating to network slicing.

It is to be noted that at least some of the entities or nodes, such as NFc 202, NFp 204, NRF 206, 208, may act in both service-consuming and service-providing roles and that their physical structure may be similar or identical, while their role in the present examples in delivery of a particular message or service is identified by use of the prefix/suffix “c” or “p” indicating whether they are acting as the service-consuming or service-producing NF. It is to be noted that instead of “c” and “p”, “v” for visited and “h” for home can be used to refer to at least some respective entities in the visited and home PLMNs. In some example implementations, a telecommunications system includes parts from multiple generations of mobile communication technology.

In some example implementations, OAuth or another authorization framework for service authorization and/or token exchange is applied between NFc 202 and NFp 204 for the purpose of authorizing an NFc to access the service of an NFp. In some of these example implementations, an NRF 206, 208 or another network entity may be or perform as an authorization server, such as an OAuth authorization server. The NFc may be an OAuth client and the NFp may operate as OAuth resource server, and they may be configured to support OAuth authorization framework.

In general, a network support function such as NRF 206 may be further configured to act as an authorization server, and provide the NFc 202 (or SCP 218 acting on behalf of the NFc) with a cryptographic access token authorizing the NFc to use the service provided by the NFp 204. In this regard, the access token is a credential that can be used by the NFc to access the service. One example of a suitable access token is an OAuth access token, which in some further examples may be formatted as a JSON Web Token (JWT). The access token may assert some number of claims that include information for the NFp to identify the NFc, scope of access, expiry, etc. The access token may include a unique token identifier, and a cryptographic signature produced using a private key of the NRF.

The NFc 202 (or SCP 218) may include the access token in a service request for access to a service provided by the NFp 204, such as in an “authorization bearer” header. In this regard, the purpose of the access token is to inform the NFp that the bearer of the token has been authorized to access the service and perform specific actions (as specified by a scope of access that has been granted). The access token may be used as a Bearer credential (and therefore at times referred to as a bearer access token), and transmitted in an HTTP Authorization header of an HTTP request message.

The NFp 204 may receive the service request and perform a validation of the access token before allowing access to the service. The NFp may verify validity of the cryptographic signature using the corresponding public key of the NRF 206, which the NFp may obtain in connection with registering the service(s) it provides with the NRF. The NFp may also validate the claims asserted in the access token (the information for the NFp to identify the NFc, scope of access, expiry, etc.). In some examples, this validation may include verifying the access token has not expired based on its expiry, which may be sufficient to enable the NFc to reuse the access token.

When the validation is unsuccessful, the NFp 204 may send an error response, such as an HTTP error response message that includes an appropriate HTTP status code. The Bearer authentication scheme for bearer access tokens uses an WWW-Authenticate header that contains at least one challenge applicable to the requested service. The WWW-Authenticate header identifies the authentication scheme, and includes a number of attribute-value pairs that carry respective parameters.

When the NFp 204 rejects a service request without an access token or an invalid access token, the NFp may send an HTTP error response message that includes an 401 “Unauthorized” status code. The HTTP error response message may include an WWW-Authenticate header in which the authentication scheme is set to “Bearer.” The attribute-value pairs in the WWW-Authenticate header may include “realm” and “error” attributes. The “realm” attribute may be set to a uniform resource identifier (URI) of the service (e.g., API URI) for which the access failed, in the case of request/response service operations. The “error” attribute may be set to “invalid_token” if the request contained an access token that the NFp deemed invalid (e.g., expired, malformed); or the WWW-Authenticate header may omit the “error” attribute if the request did not contain an access token.

When the NFp 204 rejects a service request in which the access token did not include a scope required to invoke a service operation, the NFp may send an HTTP error response message that includes an 403 “Forbidden” status code. The WWW-Authenticate header in this error response message may also set the authentication scheme to “Bearer,” and set the “realm” attribute to the URI of the service for which the access failed, in the case of request/response service operations. The “error” attribute may be set to “insufficient_scope,” and the WWW-Authenticate header may include a “scope” attribute set with the scope(s) necessary to access the service.

Although the error response message conveys some information regarding an unsuccessful validation of an access token, there is currently no standard framework by which the NFp 204 may communicate that it requires access tokens for a service to contain certain claims, or that validation of an access token failed because it omitted one or more of those claims. This problem may not be solved simply by communicating the error response message to the NFc, as the NFc may still cache and attempt to reuse the access token until the access token expires.

Example implementations of the present disclosure therefore provide a framework by which an NFp 204 may communicate at least one missing claim from an access token provided by an NFc 202 in a service request for access to a service provided by the NFp. This framework may be backward compatible in that the NFc may indicate to the NFp that the NFc supports receiving missing claims information; and the NFp may determine to communicate the missing claim(s) based on operator policies defined at the NFp. According to some examples, the missing claim(s) may be indicated in the error response to the NFc, such as in the WWW-Authenticate header of an HTTP error response message. In other examples, the missing claim(s) may be indicated in in a problem details object (e.g., “ProblemDetails”) of an HTTP error response message payload. The NFc may thereby be notified of the missing claim(s), and retrieve a second access token from the NRF 206 or other authorization server that includes the missing claim(s), which may then be presented to the NFp to access the service.

Some example implementations therefore provide a NFc 202 configured to send a service request to a NFp 204 for access to a service provided by the NFp. The service request includes an access token that asserts one or more claims and represents an access authorization issued to the NFc. In some examples, the service request may also include a supported feature indication that indicates support for receiving missing claims information.

The NFp 204 is configured to receive the service request, and perform a validation of the access token in which a determination is made that at least one claim is missing from the claim(s) asserted by the access token. The NFp is configured to send an error response to the NFc 202 based on the validation; and in some examples, based on the supported feature indication from the NFc. The error response indicates the service request is rejected, and indicates the missing claim(s).

As indicated above, in various some examples, the missing claim(s) may be indicated in a field of a WWW-Authenticate header of an HTTP error response message, or in a problem details object of a message payload. In some examples, the error response identifies the missing claim(s), or includes a resource identifier (e.g., URI) of a resource at which the missing claim(s) is identified. In other examples, the error response identifies one or more required claims, or includes a resource identifier (e.g., URI) of a resource at which the required claim(s) are identified. In some of these other examples, the NFc 202 may be configured to determine the missing claim(s) based on a comparison of the required claim(s) and the claim(s) asserted by the access token.

The NFc 202 is configured to receive the error response from the NFp 204; and based on the error response, the NFc is configured to retrieve a second access token that asserts a plurality of claims including the claim(s) and the missing claim(s). In this regard, in some examples, the NFc is configured to send an access token request to a NRF 206 to request the second access token, and receive the second access token from the NRF based on the access token request. The NFc may then be configured to access the service provided by the NFp based on the second access token.

As indicated above, in some examples, the missing claim(s) may be indicated in a field of a WWW-Authenticate header of the HTTP error response message. As indicated above, the WWW-Authenticate header may include an “error” attribute, which may provide a reason why the service request was rejected. In some of these examples, the WWW-Authenticate header may include an “error_description” attribute and/or an “error_uri” attribute, either of which may be used to convey the missing claim(s). As currently specified, these attributes include human-readable information; but according to some example implementations of the present disclosure, either or both attributes may be repurposed to indicate the missing claim(s). In this regard, the WWW-Authenticate header may include an “error_description” attribute set to indicate the missing claim(s) (e.g., error_description=“Missing OAuth Claims: <comma separated list of one or more claim names>”). In another example, the WWW-Authenticate header may include an “error_uri” attribute set to include the URI of a webpage or other resource at which the missing claim(s) are indicated. In these and other examples, the missing claims(s) may be identified by claim names, which may be 3GPP or Internet Assigned Numbers Authority (IANA) defined identifiers (IDs) or URIs.

As also indicated above, in some examples, the missing claim(s) may be indicated in a problem details object of the message payload of an HTTP error response message. The problem details object may be formatted as a JSON object, such as in the manner described by the Internet Engineering Task Force (IETF) RFC 7808, “Problem Details for HTTP APIs.” In some of these examples, HTTP response messages from the NFp 204, including 401 (Unauthorized) and 403 (Forbidden) error response messages, may be formatted by status code to include appropriate as follows:
‘204’:
   description: Expected response to a valid request
‘400’:
   $ref: ‘TS29571_CommonData.yaml #/components/responses/400’
‘401’:
   description: Unauthorized Request
   content:
      application/problem+json:
   schema:
      $ref: ‘TS29571_CommonData.yaml #/components/schemas/ProblemDetails’
‘429’:
   $ref: ‘TS29571_CommonData.yaml #/components/responses/429’
‘500’:
   $ref: ‘TS29571_CommonData.yaml #/components/responses/500’

### Problem Details:

description: Provides additional information in an error response.
type: object
properties:
   type:
      $ref: ‘#/components/schemas/Uri’
title:
   type: string
status:
   type: integer
missingOAuthClaims:
   type: array
   items:
   $ref: ‘TS29571_CommonData.yaml #/components/schemas/JsonAttributes’
   minItems: 1
      And one example definition for JSON attributes may include:
Json Attributes:
   type: string
   description: Json attributes that usually occur in Access TokenReq.
      Ex: targetSnssaiList

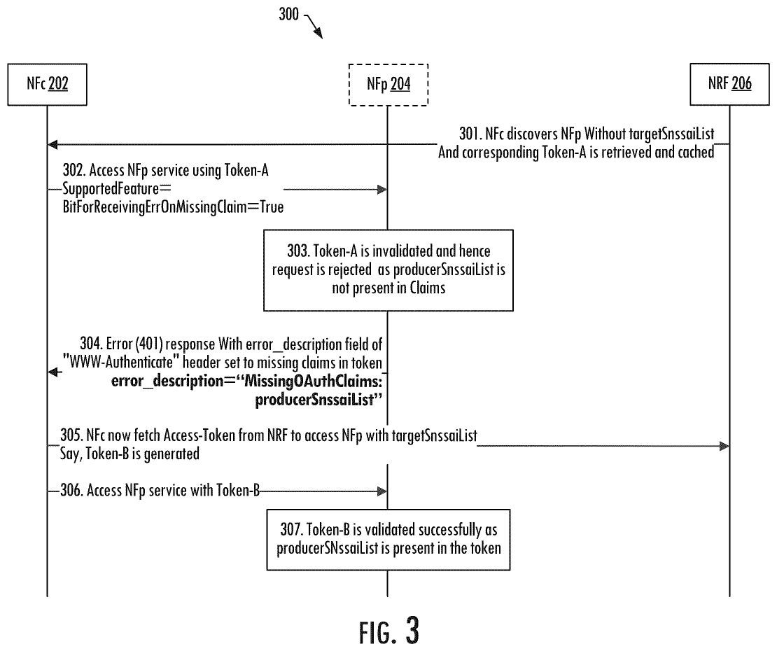

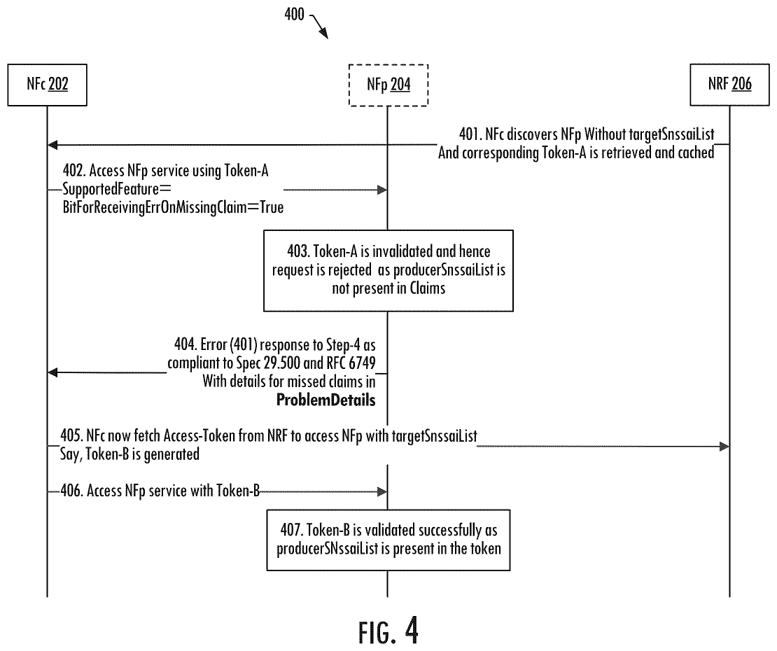

To further illustrate various example implementations of the present disclosure, FIGS. 3 and 4 are signaling charts 300, 400 of access token request and validation, according to various example implementations. In the illustrated examples, access to a service provided by the NFp 204 requires (a claim) regarding a list of S-NSSAIs (single-network slice selection assistance information) of the NFp. As shown in FIG. 3, in some examples, the NFc 202 at step 301 receives an access token (Token-A) from the NRF 206 to use one or more services provided by the NFp. The NFc discovers those service(s) without indicating a list of S-NSSAIs (targetSnssaiList); and accordingly, the access token is missing information regarding the S-NSSAIs of the NFp.

The NFc 202 at step 302 sends a service request to the NFp 204 that includes the token, and a supported feature indication (BitForReceivingErrOnMissingClaim) that is set indicate the NFc supports receiving missing claims information. As shown at step 303, the NFp performs a validation of the access token in which a determination is made that the access token is missing a claim with the NFp's S-NSSAIs (producerSnssaiList). The NFp therefore at step 304 rejects the service request in an HTTP error response message with status code 401, and including an “error_description” attribute in the WWW-Authenticate header set to indicate the missing claim.

The NFc 202 receives the HTTP error response message that indicates the missing claim; and at step 305, the NFc fetches or otherwise retrieves a second token (Token-B) indicating the previously-missing list of S-NSSAIs (targetSnssaiList). The NFc at step 306 sends a service request to the NFp 204 that includes the second token, which includes the previously-missing claim with the NFp's S-NSSAIs (producerSnssaiList). The NFp then at step 307 successfully validates the second token, as the second token includes the NFp's S-NSSAIs.

Similar to FIG. 3 in FIG. 4, the NFc 202 at step 401 receives an access token (Token-A) from the NRF 206 to use one or more services provided by the NFp. The NFc discovers those service(s) without indicating a list of S-NSSAIs (targetSnssaiList); and accordingly, the access token is missing information regarding the S-NSSAIs of the NFp. The NFc at step 402 sends a service request to the NFp 204 that includes the token, and a supported feature indication (BitForReceivingErrOnMissingClaim) that is set indicate the NFc supports receiving missing claims information. The NFp at step 403 performs a validation of the access token in which a determination is made that the access token is missing a claim with the NFp's S-NSSAIs (producerSnssaiList).

In FIG. 4, the NFp 204 at step 404 rejects the service request in an HTTP error response message with status code 401. This HTTP error response message may be compliant with 3GPP TS 29.500 and IETF RFC 6749, and include a message payload with a problem details object that indicates the missing claim. Again, similar to before, the NFc 202 receives the HTTP error response message that indicates the missing claim; and at step 405, the NFc fetches or otherwise retrieves a second token (Token-B) indicating the previously-missing list of S-NSSAIs (targetSnssaiList). The NFc at step 406 sends a service request to the NFp 204 that includes the second token, which includes the previously-missing claim with the NFp's S-NSSAIs (producerSnssaiList). The NFp then at step 407 successfully validates the second token, as the second token includes the NFp's S-NSSAIs.

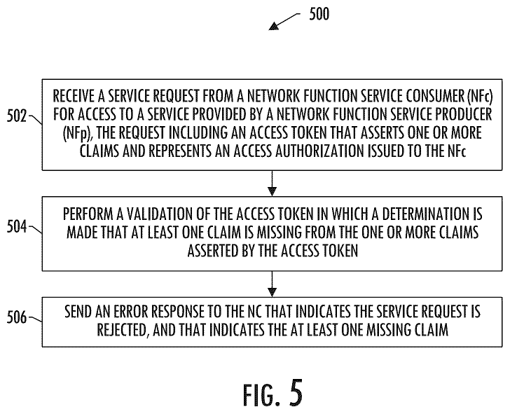

FIG. 5 is a flowchart illustrating various steps in a method 500 implemented at a network function service producer (NFp), according to some example implementations. The method includes receiving a service request from a network function service consumer (NFc) for access to a service provided by the NFp, the request including an access token that asserts one or more claims and represents an access authorization issued to the NFc, as shown at block 502. The method includes performing a validation of the access token in which a determination is made that at least one claim is missing from the one or more claims asserted by the access token, as shown at block 504. And based on the validation, the method includes sending an error response to the NFc that indicates the service request is rejected, and that indicates the at least one missing claim, as shown at block 506.

In some examples, the service request includes a supported feature indication that indicates support for receiving missing claims information, and the error response is sent at block 506 based on the supported feature indication.

In some examples, the error response identifies the at least one missing claim, or includes a resource identifier of a resource at which the at least one missing claim is identified.

In some examples, the error response identifies one or more required claims, or includes a resource identifier of a resource at which the one or more required claims are identified.

In some examples, the service request is formatted as a Hypertext Transfer Protocol (HTTP) request message, the error response is formatted as an HTTP error response message that includes a WWW-Authenticate header, and the at least one missing claim is indicated in a field of the WWW-Authenticate header.

In some examples, the service request is formatted as a Hypertext Transfer Protocol (HTTP) request message, the response is formatted as an HTTP response message that includes a message payload, and the at least one missing claim is indicated in a problem details object of the message payload.

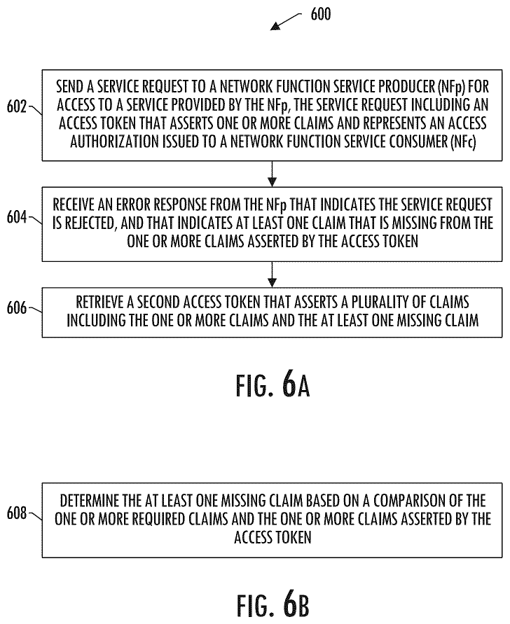

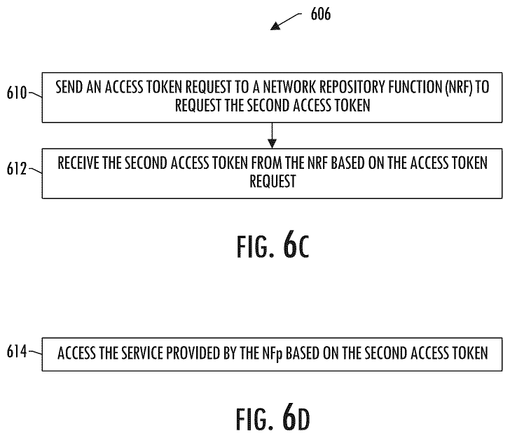

FIGS. 6A-6D are flowcharts illustrating various steps in a method 600 implemented at a network function service consumer (NFc), according to various example implementations. The method includes sending a service request to a network function service producer (NFp) for access to a service provided by the NFp, the service request including an access token that asserts one or more claims and represents an access authorization issued to the NFc, as shown at block 602 of FIG. 6A. The method includes receiving an error response from the NFp that indicates the service request is rejected, and that indicates at least one claim that is missing from the one or more claims asserted by the access token, as shown at block 604. And based on the error response, the method includes retrieving a second access token that asserts a plurality of claims including the one or more claims and the at least one missing claim, as shown at block 606.

In some examples, the service request includes a supported feature indication that indicates support for receiving missing claims information, and the error response is received at block 604 based on the supported feature indication.

In some examples, the error response identifies the at least one missing claim, or includes a resource identifier of a resource at which the at least one missing claim is identified.

In some examples, the error response identifies one or more required claims, or includes a resource identifier of a resource at which the one or more required claims are identified. In some of these examples, the method 600 further includes determining the at least one missing claim based on a comparison of the one or more required claims and the one or more claims asserted by the access token, as shown at block 608 of FIG. 6B.

In some examples, the service request is formatted as a Hypertext Transfer Protocol (HTTP) request message, the error response is formatted as an HTTP error response message that includes a WWW-Authenticate header, and the at least one missing claim is indicated in a field of the WWW-Authenticate header.

In some examples, the service request is formatted as a Hypertext Transfer Protocol (HTTP) request message, the response is formatted as an HTTP response message that includes a message payload, and the at least one missing claim is indicated in a problem details object of the message payload.

In some examples, retrieving the second access token at block 606 includes sending an access token request to a network repository function (NRF) to request the second access token, and receiving the second access token from the NRF based on the access token request, as shown at blocks 610 and 612 of FIG. 6C.

In some examples, the method 600 further includes accessing the service provided by the NFp based on the second access token, as shown at block 614 of FIG. 6D.

According to example implementations of the present disclosure, a telecommunications system 100 or PLMN 102, and its components such as NFc 202, NFp 204, NRFc 218 and/or NRFp 220, may be implemented by various means. Means for implementing the system and its components may include hardware, firmware, software, or combinations thereof. In some examples, one or more apparatuses may be configured to function as or otherwise implement the system and its components shown and described herein. In examples involving more than one apparatus, the respective apparatuses may be connected to or otherwise in communication with one another in a number of different manners, such as directly or indirectly via a wired or wireless network or the like.

According to some example implementations, at least some of the method 500 described with respect to FIG. 5 may be carried out by an apparatus comprising means for performing functions corresponding steps of the method. Similarly, at least some of the method 600 described with respect to FIGS. 6A-6D may be carried out by an apparatus comprising means for performing functions corresponding steps of the method. Examples of a suitable apparatus may include a network function or any suitable apparatus, such as a server, host or node.

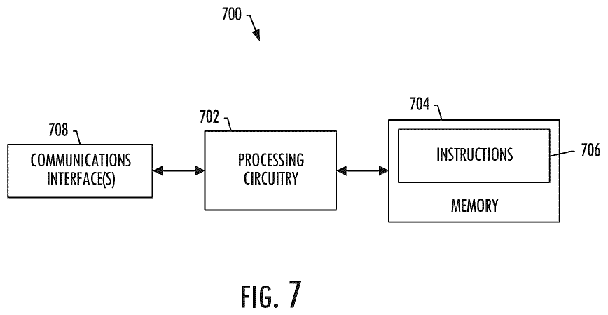

FIG. 7 illustrates an apparatus 700 in which means for performing various functions includes hardware, alone or under direction of one or more computer programs from a computer-readable storage medium or other memory, such as computer memory, according to some example implementations of the present disclosure. The apparatus may include one or more of each of a number of components such as, for example, processing circuitry 702 connected to computer-readable storage medium or other memory 704.

The processing circuitry 702 may be composed of one or more processors alone or in combination with one or more computer-readable storage media. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the memory 704 (of the same or another apparatus).

The processing circuitry 702 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The memory 704 is generally any piece of computer hardware that is capable of storing information such as, for example, data, computer programs, instructions 706 (e.g., computer-readable program code) and/or other suitable information either on a temporary basis and/or a permanent basis. The memory may include volatile and/or non-volatile memory, and may be fixed or removable. Examples of suitable memory include recording media, random access memory (RAM), read-only memory (ROM), a hard drive, a flash memory, a thumb drive, a removable computer diskette, an optical disk or some combination thereof.

The memory 704 is a non-transitory device capable of storing information. One example of a suitable memory is a computer-readable storage medium, which is distinguishable from a computer-readable transmission medium capable of carrying information from one location to another. Examples of suitable computer-readable transmission media comprise electronic carrier signals, telecommunications signals, software distribution packages, or some combination thereof. As used herein, the term “non-transitory” is a limitation of the medium itself (i.e., tangible, not a signal) as opposed to a limitation on data storage persistency (e.g., RAM versus ROM). A computer-readable medium as described herein generally refers to a computer-readable storage medium or computer-readable transmission medium. A computer-readable medium is any entity or device capable in which information, such as one or more computer programs or portions thereof, may be stored and carried.

In addition to the memory 704 (e.g., computer-readable storage medium), the processing circuitry 702 may also be connected to one or more interfaces for displaying, transmitting and/or receiving information. The interfaces may include a communications interface 708 and/or one or more user interfaces (e.g., display, user input interface). The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

Execution of the instructions 706 by the processing circuitry 702, or storage of the instructions in the memory 704, supports combinations of operations for implementing example implementations of the present disclosure. In this manner, an apparatus 700 may comprise at least one processing circuitry and at least one memory coupled to the at least one processing circuitry, where the at least one processing circuitry is configured to execute instructions stored in the at least one memory. It will also be understood that one or more functions, and combinations of functions, may be implemented by special purpose hardware-based computer systems and/or processing circuitry which perform the specified functions, or combinations of special purpose hardware and program code instructions.

Some example implementations of the present disclosure may also be carried out in the form of a computer process defined by one or more computer programs or portions thereof. Example implementations of the present disclosure may be carried out by executing at least one portion of a computer program comprising instructions. The computer program may be in source code form, object code form, or in some intermediate form. The computer program may be stored in a computer-readable medium that is readable by a computer, processing circuitry or other suitable apparatus. As indicated above, for example, the computer program may be stored in a memory, such as a computer-readable storage medium. Additionally or alternatively, for example, the computer program may be stored in a computer-readable transmission medium. The coding of software for carrying out example implementations of the present disclosure is well within the scope of a person of ordinary skill in the art.

As will be appreciated, any suitable instructions may be loaded onto a computer, a processing circuitry or other programmable apparatus from a memory or a computer-readable medium (e.g., computer-readable storage medium, computer-readable transmission medium) to produce a particular machine, such that the particular machine becomes a means for implementing the functions specified herein. The instructions may also be stored in a computer-readable medium that can direct a computer, a processing circuitry or other programmable apparatus to function in a particular manner to thereby generate a particular machine or particular article of manufacture. In some examples, the instructions stored in the computer-readable medium may produce an article of manufacture, where the article of manufacture becomes a means for implementing functions described herein. The instructions may be retrieved from a computer-readable medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of instructions comprising program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

As explained above and reiterated below, the present disclosure includes, without limitation, the following example implementations.

Clause 1. An apparatus to implement a network function service producer (NFp), the apparatus comprising: at least one memory configured to store instructions; and at least one processing circuitry configured to access the at least one memory, and execute the instructions to cause the apparatus to at least: receive a service request from a network function service consumer (NFc) for access to a service provided by the NFp, the request including an access token that asserts one or more clauses and represents an access authorization issued to the NFc; perform a validation of the access token in which a determination is made that at least one clause is missing from the one or more clauses asserted by the access token; and based on the validation, send an error response to the NFc that indicates the service request is rejected, and that indicates the at least one missing clause.

Clause 2. The apparatus of clause 1, wherein the service request includes supported feature indication that indicates support for receiving missing clauses information, and the error response is sent based on the supported feature indication.

Clause 3. The apparatus of clause 1 or clause 2, wherein the error response identifies the at least one missing clause, or includes a resource identifier of a resource at which the at least one missing clause is identified.

Clause 4. The apparatus of any of clauses 1 to 3, wherein the error response identifies one or more required clauses, or includes a resource identifier of a resource at which the one or more required clauses are identified.

Clause 5. The apparatus of any of clauses 1 to 4, wherein the service request is formatted as a Hypertext Transfer Protocol (HTTP) request message, the error response is formatted as a HTTP error response message that includes a WWW-Authenticate header, and the at least one missing clause is indicated in a field of the WWW-Authenticate header.

Clause 6. The apparatus of any of clauses 1 to 5, wherein the service request is formatted as a Hypertext Transfer Protocol (HTTP) request message, the response is formatted as a HTTP response message that includes a message payload, and the at least one missing clause is indicated in a problem details object of the message payload.

Clause 7. A apparatus to implement a network function service producer (NFp), the apparatus comprising: means for receiving a service request from a network function service consumer (NFc) for access to a service provided by the NFp, the request including an access token that asserts one or more clauses and represents an access authorization issued to the NFc; means for performing a validation of the access token in which a determination is made that at least one clause is missing from the one or more clauses asserted by the access token; and based on the validation, means for sending an error response to the NFc that indicates the service request is rejected, and that indicates the at least one missing clause.

Clause 8. The apparatus of clause 7, wherein the service request includes supported feature indication that indicates support for receiving missing clauses information, and the error response is sent based on the supported feature indication.

Clause 9. The apparatus of clause 7 or clause 8, wherein the error response identifies the at least one missing clause, or includes a resource identifier of a resource at which the at least one missing clause is identified.

Clause 10. The apparatus of any of clauses 7 to 9, wherein the error response identifies one or more required clauses, or includes a resource identifier of a resource at which the one or more required clauses are identified.

Clause 11. The apparatus of any of clauses 7 to 10, wherein the service request is formatted as a Hypertext Transfer Protocol (HTTP) request message, the error response is formatted as a HTTP error response message that includes a WWW-Authenticate header, and the at least one missing clause is indicated in a field of the WWW-Authenticate header.

Clause 12. The apparatus of any of clauses 7 to 11, wherein the service request is formatted as a Hypertext Transfer Protocol (HTTP) request message, the response is formatted as a HTTP response message that includes a message payload, and the at least one missing clause is indicated in a problem details object of the message payload.

Clause 13. A method implemented at a network function service producer (NFp), the method comprising: receiving a service request from a network function service consumer (NFc) for access to a service provided by the NFp, the request including an access token that asserts one or more clauses and represents an access authorization issued to the NFc; performing a validation of the access token in which a determination is made that at least one clause is missing from the one or more clauses asserted by the access token; and based on the validation, sending an error response to the NFc that indicates the service request is rejected, and that indicates the at least one missing clause.

Clause 14. The method of clause 13, wherein the service request includes supported feature indication that indicates support for receiving missing clauses information, and the error response is sent based on the supported feature indication.

Clause 15. The method of clause 13 or clause 14, wherein the error response identifies the at least one missing clause, or includes a resource identifier of a resource at which the at least one missing clause is identified.

Clause 16. The method of any of clauses 13 to 15, wherein the error response identifies one or more required clauses, or includes a resource identifier of a resource at which the one or more required clauses are identified.

Clause 17. The method of any of clauses 13 to 16, wherein the service request is formatted as a Hypertext Transfer Protocol (HTTP) request message, the error response is formatted as a HTTP error response message that includes a WWW-Authenticate header, and the at least one missing clause is indicated in a field of the WWW-Authenticate header.

Clause 18. The method of any of clauses 13 to 17, wherein the service request is formatted as a Hypertext Transfer Protocol (HTTP) request message, the response is formatted as a HTTP response message that includes a message payload, and the at least one missing clause is indicated in a problem details object of the message payload.

Clause 19. A computer-readable storage medium implemented at a network function service producer (NFp), the computer-readable storage medium being non-transitory and having instructions stored therein that, in response to execution by at least one processing circuitry, causes an apparatus to at least: receive a service request from a network function service consumer (NFc) for access to a service provided by the NFp, the request including an access token that asserts one or more clauses and represents an access authorization issued to the NFc; perform a validation of the access token in which a determination is made that at least one clause is missing from the one or more clauses asserted by the access token; and based on the validation, send an error response to the NFc that indicates the service request is rejected, and that indicates the at least one missing clause.

Clause 20. The computer-readable storage medium of clause 19, wherein the service request includes supported feature indication that indicates support for receiving missing clauses information, and the error response is sent based on the supported feature indication.

Clause 21. The computer-readable storage medium of clause 19 or clause 20, wherein the error response identifies the at least one missing clause, or includes a resource identifier of a resource at which the at least one missing clause is identified.

Clause 22. The computer-readable storage medium of any of clauses 19 to 21, wherein the error response identifies one or more required clauses, or includes a resource identifier of a resource at which the one or more required clauses are identified.

Clause 23. The computer-readable storage medium of any of clauses 19 to 22, wherein the service request is formatted as a Hypertext Transfer Protocol (HTTP) request message, the error response is formatted as a HTTP error response message that includes a WWW-Authenticate header, and the at least one missing clause is indicated in a field of the WWW-Authenticate header.

Clause 24. The computer-readable storage medium of any of clauses 19 to 23, wherein the service request is formatted as a Hypertext Transfer Protocol (HTTP) request message, the response is formatted as a HTTP response message that includes a message payload, and the at least one missing clause is indicated in a problem details object of the message payload.

Clause 25. An apparatus comprising means for performing the method of any of clauses 13 to 18.

Clause 26. A computer-readable medium comprising computer-readable program code that, in response to execution by at least one processing circuitry, causes an apparatus to perform the method of any of clauses 13 to 18.

Clause 27. A computer-readable storage medium comprising computer-readable program code that, in response to execution by at least one processing circuitry, causes an apparatus to perform the method of any of clauses 13 to 18.

Clause 28. A computer program comprising computer-readable program code that, in response to execution by at least one processing circuitry, causes an apparatus to perform the method of any of clauses 13 to 18.

Clause 29. An apparatus to implement a network function service consumer (NFc), the apparatus comprising: at least one memory configured to store instructions; and at least one processing circuitry configured to access the at least one memory, and execute the instructions to cause the apparatus to at least: send a service request to a network function service producer (NFp) for access to a service provided by the NFp, the service request including an access token that asserts one or more clauses and represents an access authorization issued to the NFc; receive an error response from the NFp that indicates the service request is rejected, and that indicates at least one clause that is missing from the one or more clauses asserted by the access token; and base on the error response, retrieve a second access token that asserts a plurality of clauses including the one or more clauses and the at least one missing clause.

Clause 30. The apparatus of clause 29, wherein the service request includes supported feature indication that indicates support for receiving missing clauses information, and the error response is received based on the supported feature indication.

Clause 31. The apparatus of clause 29 or clause 30, wherein the error response identifies the at least one missing clause, or includes a resource identifier of a resource at which the at least one missing clause is identified.

Clause 32. The apparatus of any of clauses 29 to 31, wherein the error response identifies one or more required clauses, or includes a resource identifier of a resource at which the one or more required clauses are identified, and wherein the at least one processing circuitry is configured to execute the instructions to cause the apparatus to further determine the at least one missing clause based on a comparison of the one or more required clauses and the one or more clauses asserted by the access token.

Clause 33. The apparatus of any of clauses 29 to 32, wherein the service request is formatted as a Hypertext Transfer Protocol (HTTP) request message, the error response is formatted as a HTTP error response message that includes a WWW-Authenticate header, and the at least one missing clause is indicated in a field of the WWW-Authenticate header.

Clause 34. The apparatus of any of clauses 29 to 33, wherein the service request is formatted as a Hypertext Transfer Protocol (HTTP) request message, the response is formatted as a HTTP response message that includes a message payload, and the at least one missing clause is indicated in a problem details object of the message payload.

Clause 35. The apparatus of any of clauses 29 to 34, wherein the apparatus caused to retrieve the second access token includes the apparatus caused to: send an access token request to a network repository function (NRF) to request the second access token; and receive the second access token from the NRF based on the access token request.

Clause 36. The apparatus of any of clauses 29 to 35, wherein the at least one processing circuitry is configured to execute the instructions to cause the apparatus to further access the service provided by the NFp based on the second access token.

Clause 37. A apparatus to implement a network function service consumer (NFc), the apparatus comprising: means for sending a service request to a network function service producer (NFp) for access to a service provided by the NFp, the service request including an access token that asserts one or more clauses and represents an access authorization issued to the NFc: means for receiving an error response from the NFp that indicates the service request is rejected, and that indicates at least one clause that is missing from the one or more clauses asserted by the access token; and based on the error response, means for retrieving a second access token that asserts a plurality of clauses including the one or more clauses and the at least one missing clause.

Clause 38. The apparatus of clause 37, wherein the service request includes supported feature indication that indicates support for receiving missing clauses information, and the error response is received based on the supported feature indication.

Clause 39. The apparatus of clause 37 or clause 38, wherein the error response identifies the at least one missing clause, or includes a resource identifier of a resource at which the at least one missing clause is identified.

Clause 40. The apparatus of any of clauses 37 to 39, wherein the error response identifies one or more required clauses, or includes a resource identifier of a resource at which the one or more required clauses are identified, and wherein the apparatus further comprises means for determining the at least one missing clause based on a comparison of the one or more required clauses and the one or more clauses asserted by the access token.

Clause 41. The apparatus of any of clauses 37 to 40, wherein the service request is formatted as a Hypertext Transfer Protocol (HTTP) request message, the error response is formatted as a HTTP error response message that includes a WWW-Authenticate header, and the at least one missing clause is indicated in a field of the WWW-Authenticate header.

Clause 42. The apparatus of any of clauses 37 to 41, wherein the service request is formatted as a Hypertext Transfer Protocol (HTTP) request message, the response is formatted as a HTTP response message that includes a message payload, and the at least one missing clause is indicated in a problem details object of the message payload.

Clause 43. The apparatus of any of clauses 37 to 42, wherein the means for retrieving the second access token includes: means for sending an access token request to a network repository function (NRF) to request the second access token; and means for receiving the second access token from the NRF based on the access token request.

Clause 44. The apparatus of any of clauses 37 to 43, wherein the apparatus further comprises means for accessing the service provided by the NFp based on the second access token.

Clause 45. A method implemented at a network function service consumer (NFc), the method comprising: sending a service request to a network function service producer (NFp) for access to a service provided by the NFp, the service request including an access token that asserts one or more clauses and represents an access authorization issued to the NFc; receiving an error response from the NFp that indicates the service request is rejected, and that indicates at least one clause that is missing from the one or more clauses asserted by the access token; and based on the error response, retrieving a second access token that asserts a plurality of clauses including the one or more clauses and the at least one missing clause.

Clause 46. The method of clause 45, wherein the service request includes supported feature indication that indicates support for receiving missing clauses information, and the error response is received based on the supported feature indication.

Clause 47. The method of clause 45 or clause 46, wherein the error response identifies the at least one missing clause, or includes a resource identifier of a resource at which the at least one missing clause is identified.

Clause 48. The method of any of clauses 45 to 47, wherein the error response identifies one or more required clauses, or includes a resource identifier of a resource at which the one or more required clauses are identified, and wherein the method further comprises determining the at least one missing clause based on a comparison of the one or more required clauses and the one or more clauses asserted by the access token.

Clause 49. The method of any of clauses 45 to 48, wherein the service request is formatted as a Hypertext Transfer Protocol (HTTP) request message, the error response is formatted as a HTTP error response message that includes a WWW-Authenticate header, and the at least one missing clause is indicated in a field of the WWW-Authenticate header.

Clause 50. The method of any of clauses 45 to 49, wherein the service request is formatted as a Hypertext Transfer Protocol (HTTP) request message, the response is formatted as a HTTP response message that includes a message payload, and the at least one missing clause is indicated in a problem details object of the message payload.

Clause 51. The method of any of clauses 45 to 50, wherein retrieving the second access token includes: sending an access token request to a network repository function (NRF) to request the second access token; and receiving the second access token from the NRF based on the access token request.

Clause 52. The method of any of clauses 45 to 51, wherein the method further comprises accessing the service provided by the NFp based on the second access token.

Clause 53. A computer-readable storage medium implemented at a network function service consumer (NFc), the computer-readable storage medium being non-transitory and having instructions stored therein that, in response to execution by at least one processing circuitry, causes an apparatus to at least: send a service request to a network function service producer (NFp) for access to a service provided by the NFp, the service request including an access token that asserts one or more clauses and represents an access authorization issued to the NFc; receive an error response from the NFp that indicates the service request is rejected, and that indicates at least one clause that is missing from the one or more clauses asserted by the access token; and base on the error response, retrieve a second access token that asserts a plurality of clauses including the one or more clauses and the at least one missing clause.

Clause 54. The computer-readable storage medium of clause 53, wherein the service request includes supported feature indication that indicates support for receiving missing clauses information, and the error response is received based on the supported feature indication.

Clause 55. The computer-readable storage medium of clause 53 or clause 54, wherein the error response identifies the at least one missing clause, or includes a resource identifier of a resource at which the at least one missing clause is identified.

Clause 56. The computer-readable storage medium of any of clauses 53 to 55, wherein the error response identifies one or more required clauses, or includes a resource identifier of a resource at which the one or more required clauses are identified, and wherein the computer-readable storage medium has further instructions stored therein that, in response to execution by the at least one processing circuitry, causes the apparatus to further determine the at least one missing clause based on a comparison of the one or more required clauses and the one or more clauses asserted by the access token.

Clause 57. The computer-readable storage medium of any of clauses 53 to 56, wherein the service request is formatted as a Hypertext Transfer Protocol (HTTP) request message, the error response is formatted as a HTTP error response message that includes a WWW-Authenticate header, and the at least one missing clause is indicated in a field of the WWW-Authenticate header.

Clause 58. The computer-readable storage medium of any of clauses 53 to 57, wherein the service request is formatted as a Hypertext Transfer Protocol (HTTP) request message, the response is formatted as a HTTP response message that includes a message payload, and the at least one missing clause is indicated in a problem details object of the message payload.

Clause 59. The computer-readable storage medium of any of clauses 53 to 58, wherein the apparatus caused to retrieve the second access token includes the apparatus caused to: send an access token request to a network repository function (NRF) to request the second access token; and receive the second access token from the NRF based on the access token request.

Clause 60. The computer-readable storage medium of any of clauses 53 to 59, wherein the computer-readable storage medium has further instructions stored therein that, in response to execution by the at least one processing circuitry, causes the apparatus to further access the service provided by the NFp based on the second access token.

Clause 61. An apparatus comprising means for performing the method of any of clauses 45 to 52.

Clause 62. A computer-readable medium comprising computer-readable program code that, in response to execution by at least one processing circuitry, causes an apparatus to perform the method of any of clauses 45 to 52.

Clause 63. A computer-readable storage medium comprising computer-readable program code that, in response to execution by at least one processing circuitry, causes an apparatus to perform the method of any of clauses 45 to 52.

Clause 64. A computer program comprising computer-readable program code that, in response to execution by at least one processing circuitry, causes an apparatus to perform the method of any of clauses 45 to 52.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A apparatus to implement a network function service producer (NFp), the apparatus comprising: at least one processor; and at least one memory storing instructions that, when executed by the at least one processor, cause the apparatus at least to perform:
receiving a service request from a network function service consumer (NFc) for access to a service provided by the NFp, the request including an access token that asserts one or more claims and represents an access authorization issued to the NFc;
performing a validation of the access token in which a determination is made that at least one claim is missing from the one or more claims asserted by the access token; and based on the validation,
sending an error response to the NFc that indicates the service request is rejected, and that indicates the at least one missing claim.

2. The apparatus of claim 1, wherein the service request includes a supported feature indication that indicates support for receiving missing claims information, and the error response is sent based on the supported feature indication.

3. The apparatus of claim 1, wherein the error response identifies the at least one missing claim, or includes a resource identifier of a resource at which the at least one missing claim is identified.

4. The apparatus of claim 1, wherein the error response identifies one or more required claims, or includes a resource identifier of a resource at which the one or more required claims are identified.

5. The apparatus of claim 1, wherein the service request is formatted as a Hypertext Transfer Protocol (HTTP) request message, the error response is formatted as an HTTP error response message that includes a WWW-Authenticate header, and the at least one missing claim is indicated in a field of the WWW-Authenticate header.

6. The apparatus of claim 1, wherein the service request is formatted as a Hypertext Transfer Protocol (HTTP) request message, the response is formatted as an HTTP response message that includes a message payload, and the at least one missing claim is indicated in a problem details object of the message payload.

7. A method implemented at a network function service producer (NFp), the method comprising:
receiving a service request from a network function service consumer (NFc) for access to a service provided by the NFp, the request including an access token that asserts one or more claims and represents an access authorization issued to the NFc;
performing a validation of the access token in which a determination is made that at least one claim is missing from the one or more claims asserted by the access token; and based on the validation,
sending an error response to the NFc that indicates the service request is rejected, and that indicates the at least one missing claim.

8. The method of claim 7, wherein the service request includes a supported feature indication that indicates support for receiving missing claims information, and the error response is sent based on the supported feature indication.

9. The method of claim 7, wherein the service request is formatted as a Hypertext Transfer Protocol (HTTP) request message, the error response is formatted as an HTTP error response message that includes a WWW-Authenticate header, and the at least one missing claim is indicated in a field of the WWW-Authenticate header.

10. The method of claim 7, wherein the service request is formatted as a Hypertext Transfer Protocol (HTTP) request message, the response is formatted as an HTTP response message that includes a message payload, and the at least one missing claim is indicated in a problem details object of the message payload.

11. A apparatus to implement a network function service consumer (NFc), the apparatus comprising: at least one processor; and at least one memory storing instructions that, when executed by the at least one processor, cause the apparatus at least to perform:
sending a service request to a network function service producer (NFp) for access to a service provided by the NFp, the service request including an access token that asserts one or more claims and represents an access authorization issued to the NFc;
receiving an error response from the NFp that indicates the service request is rejected, and that indicates at least one claim that is missing from the one or more claims asserted by the access token; and based on the error response,
retrieving a second access token that asserts a plurality of claims including the one or more claims and the at least one missing claim.

12. The apparatus of claim 11, wherein the error response identifies the at least one missing claim, or includes a resource identifier of a resource at which the at least one missing claim is identified.

13. The apparatus of claim 11, wherein the error response identifies one or more required claims, or includes a resource identifier of a resource at which the one or more required claims are identified, and
wherein the apparatus is further caused to perform: determining the at least one missing claim based on a comparison of the one or more required claims and the one or more claims asserted by the access token.

14. The apparatus of claim 11, wherein the service request is formatted as a Hypertext Transfer Protocol (HTTP) request message, the error response is formatted as an HTTP error response message that includes a WWW-Authenticate header, and the at least one missing claim is indicated in a field of the WWW-Authenticate header.

15. The apparatus of claim 11, wherein the service request is formatted as a Hypertext Transfer Protocol (HTTP) request message, the response is formatted as an HTTP response message that includes a message payload, and the at least one missing claim is indicated in a problem details object of the message payload.

16. The apparatus of claim 11, wherein the retrieving the second access token includes:
sending an access token request to a network repository function (NRF) to request the second access token; and
receiving the second access token from the NRF based on the access token request.
